(19) United States
(12) Patent Application Publication
(10) Pub. No.: US 2026/0171857 A1
(43) Pub. Date: Jun. 18, 2026

(54) STATOR

(71) Applicants: TOYOTA JIDOSHA KABUSHIKI KAISHA, Toyota-shi (JP); Matsuo Industries, Inc., Obu-shi (JP)

(72) Inventors: Kengo OHIRA, Toyota-shi (JP); Masato NINAGAWA, Toyota-shi (JP); Takashi KADOWAKI, Toyota-shi (JP); Masayuki INADA, Toyota-shi (JP); Kazuomi TAKEUCHI, Obu-shi (JP)

(73) Assignees: TOYOTA JIDOSHA KABUSHIKI KAISHA, Toyota-shi (JP); Matsuo Industries, Inc., Obu-shi (JP)

(21) Appl. No.: 19/412,957

(22) Filed: Dec. 9, 2025

(30) Foreign Application Priority Data
Dec. 18, 2024 (JP) 2024-221241

(51) Int. Cl. H02K 1/16; H02K 3/12; H02K 11/20

(52) U.S. Cl. CPC H02K 1/16; H02K 3/12; H02K 11/20

(57) ABSTRACT

A stator of the present disclosure is disposed in a case and includes a stator core, a stator coil wound around the stator core, a sensor holding member that is integrated with a conductor included in the stator coil and that holds a temperature sensor, and a connector support portion that is formed in the sensor holding member to detachably support a connector connected to the temperature sensor via a cable. The stator suppresses the enlargement of assembly equipment and the case and improves the ease of assembly of the case.

### CROSS-REFERENCE TO RELATED APPLICATION

The present disclosure claims priority to Japanese Patent Application No. 2024-221241 filed on Dec. 18, 2024, which is incorporated herein by reference in its entirety including specification, drawings and claims.

### TECHNICAL FIELD

The present disclosure relates to a stator of a rotating electric machine that is disposed in a case.

### BACKGROUND

A conventionally known stator unit includes a stator and a thermistor that detects the temperature of the stator (see, for example, Patent Literature 1). The thermistor includes a fixing portion that is fixed to the stator, and a holder is attached to the fixing portion. The wiring of the thermistor includes a first portion that is exposed to the outside and a second portion that is covered with a tube. Further, the holder includes a hook that hooks the first portion of the wiring of the thermistor and a holding portion that holds the tube bent multiple times. In this stator unit, the hook restricts the position of the first portion, and the holding portion positions the tube of the second portion. This allows the wiring of the thermistor to be easily positioned, and prevents the exposed portion of the wiring from coming into contact with the stator core.

### CITATION LIST

### Patent Literature

[Patent Literature 1] Japanese Patent Application Laid Open No. 2022-142097

### SUMMARY

However, with the above-mentioned conventional stator units, when assembling the stator in the case, the connector and tube connected to the thermistor fixed to the stator may move and interfere with the case and the like. This necessitates securing a large range of movement for the connector and the like, and suppressing interference between the moving connector and the case and the like, making it difficult to suppress the enlargement of the assembly equipment and the case. In addition, when the connector moves, it becomes difficult to have a robot grip the connector and connect it to a receptacle provided in the case, and it becomes necessary to connect the connector to the receptacle by hand.

A main object of the present disclosure is to suppress the enlargement of assembly equipment and the case and improve the ease of assembly of the case.

The stator of the present disclosure is disposed in a case and includes a stator core, a stator coil wound around the stator core, a sensor holding member, and a connector support portion. The sensor holding member is integrated with a conductor included in the stator coil and holds a temperature sensor. The connector support portion is formed in the sensor holding member to detachably support a connector connected to the temperature sensor via a cable. Thus, by supporting the connector of the temperature sensor on the connector support portion when assembling the stator in the case, the movement of the connector is restricted, and the movement range of the connector and cable is narrowed. As a result, the need to secure a large movement range for the connector and the like, and to suppress interference between the moving connector, etc., and the case, etc., is reduced, thereby making it possible to suppress the enlargement of the stator assembly equipment and the case. Further, in the stator of the present disclosure, the connector supported by the connector support portion is easily grasped by a robot and coupled to a corresponding receptacle. As a result, there is no need to manually couple the connector to the receptacle, thereby improving the ease of assembly of the stator to the case.

The connector may be coupled to a receptacle disposed in the case, and the connector support portion may be formed to hold the cable that extends between the temperature sensor and the connector coupled to the receptacle. The sensor holding member may include a cable support portion that slidably supports the cable connected to the temperature sensor and the connector. The connector support portion may include an insertion portion that is detachably inserted into a recess formed in the connector, or a fitting portion into which the connector is detachably fitted. The conductor may be a power line or a neutral line connected to the stator coil.

### BRIEF DESCRIPTION OF DRAWINGS

FIG. 1 is a schematic configuration diagram illustrating the stator of the present disclosure;

FIG. 2 is a perspective view illustrating an essential part of the stator of the present disclosure;

FIG. 3 is a perspective view illustrating the sensor holding member included in the stator of the present disclosure:

FIG. 4 is a partial cross-sectional view illustrating the sensor holding member included in the stator of the present disclosure;

FIG. 5 is a partial cross-sectional view illustrating the sensor holding member included in the stator of the present disclosure; and

FIG. 6 is a partial cross-sectional view illustrating another aspect of the sensor holding member included in the stator of the present disclosure.

### DESCRIPTION OF EMBODIMENTS

The following describes some aspects of the present disclosure with reference to drawings.

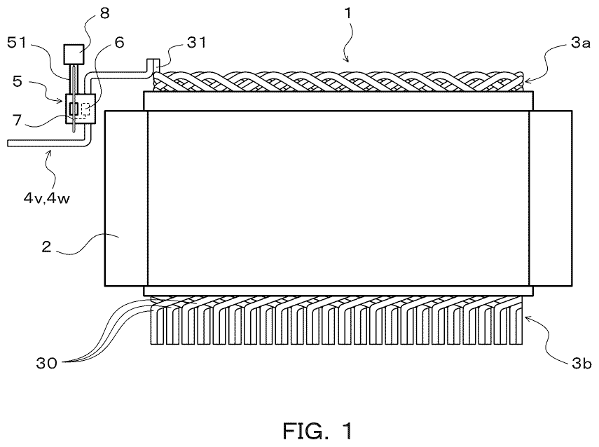

FIG. 1 is a schematic configuration diagram illustrating a stator 1 of the present disclosure. The stator 1 shown in FIG. 1, together with a rotor not shown in the figure, constitutes a three-phase alternating current motor that is used as a driving source or a generator in an electric vehicle (BEV), a fuel cell vehicle (FCV), or a hybrid vehicle (PHEV, HEV), for example. As shown in the figure, the stator 1 includes a stator core 2 and three-phase (three U, V, and W phases) stator coils 3u, 3v, and 3w wound around the stator core 2.

The stator core 2 is formed by laminating a plurality of electromagnetic steel sheets and connecting them in a laminated direction by caulking. The stator core 2 may be formed in an annular shape by, for example, pressing and sintering ferromagnetic powder. The stator core 2 includes a central hole in which the rotor is disposed, an annular outer circumference portion (yoke portion), and a plurality of teeth portions that extend in a radial direction from the outer circumference portion toward an axis and are disposed at a certain interval in a circumferential direction, and a plurality of slots (in this embodiment, for example, 48 slots) formed between adjacent teeth portions. The plurality of slots extend in the radial direction of the stator core 2 and are arranged in the circumferential direction at a certain interval, and open at the center hole.

The stator coils 3u, 3v, and 3w are formed by electrically connecting a plurality of segment coils (coil wires) 30, and are connected to each other by a star connection (Y connection), for example. The stator coils 3u, 3v, and 3w may be so-called open windings. The segment coil 30 is an electrical conductor formed by bending a rectangular wire with an insulation coating on its surface, for example made of enamel resin, into an approximately U-shape, and has a pair (two) of legs. The two legs of each segment coil 30 are inserted into different slots of the stator core 2 from one end face (top face in FIG. 1) of the stator core 2, and the legs of each segment coil 30 protruding from the other end face (bottom face in FIG. 1) of the stator core 2 are bent.

Further, a straight rod-shaped segment coil (I-segment) 31 formed from the rectangular wire with the insulation coating on its surface, for example enamel resin, is inserted from the one end face into the predetermined multiple slots (in this embodiment, for example, six) of the stator core 2, and the segment coil 31 protruding from the other end face of the stator core 2 is also bent. After the bending process is complete, tips of each segment coil 30, 31 are electrically welded to the tip of the corresponding other segment coil 30 that is adjacent to it in the radial direction of the stator core 2. Thus, the plurality of stator coils 3u, 3v, and 3w are wound around the stator core 2. In addition, an annular coil end portions 3a of the stator coils 3u, 3v, and 3w protrude from one end face of the stator core 2, and an annular coil end portions 3b of the stator coils 3u, 3v, and 3w protrude from the other end face of the stator core 2.

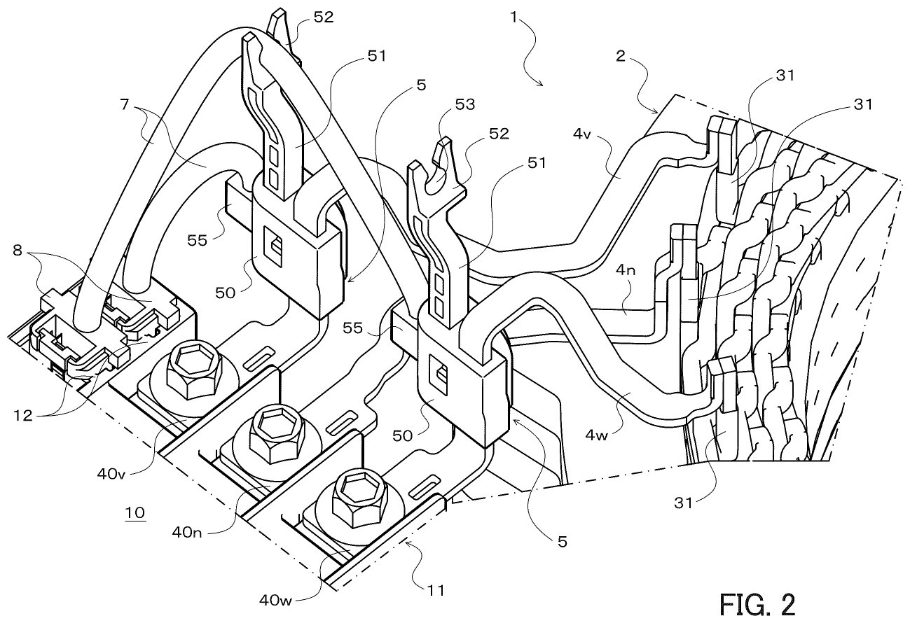

Further, the tips of three of the segment coils 31 (in this embodiment, for example, six) that are inserted into the slots of the stator core 2 are respectively electrically welded to a proximal end of the corresponding U-phase power line 4u, V-phase power line 4v, or W-phase power line (not shown). Furthermore, the tips of the remaining three segment coils 31 are respectively electrically welded to a proximal end of neutral lines 4n (see FIG. 2). The power lines 4u, 4v and the neutral lines 4n are all electrical conductors such as bus bars. In addition, tips 40u, 40v, 40n of the power lines 4u and the like serve as terminals and are electrically connected to a terminal block 11 mounted (fixed) on a case 10 of the rotating electric machine when the stator 1 is assembled in the case 10. The power lines 4u, 4v and the like are electrically connected to the inverter via the power lines and the like not shown in the figure, which are connected to the terminal block 11, and each neutral line 4n is electrically connected to the neutral point not shown in the figure.

Furthermore, in this embodiment, as shown in FIGS. 1 and 2, a sensor holding member 5 is integrated (fixed) with the power lines 4v and 4w of the V phase and W phase, for example. The sensor holding member 5 holds (contains) a temperature sensor (thermistor) 6 that detects the temperature of the power lines 4v or 4w, that is, the stator coils 3v or 3w. The temperature sensor 6 is electrically connected to a connector (connector plug) 8 via a cable 7 that includes two wires 7w and a tube 7t that covers the two wires 7w. As shown in FIG. 2, the connector 8 connected to the temperature sensor 6 is coupled to a corresponding receptacle 12 mounted in the case 10, thereby connecting the temperature sensor 6 to an electronic control device and the like, not shown, via the connector 8 and receptacle 12 and the like.

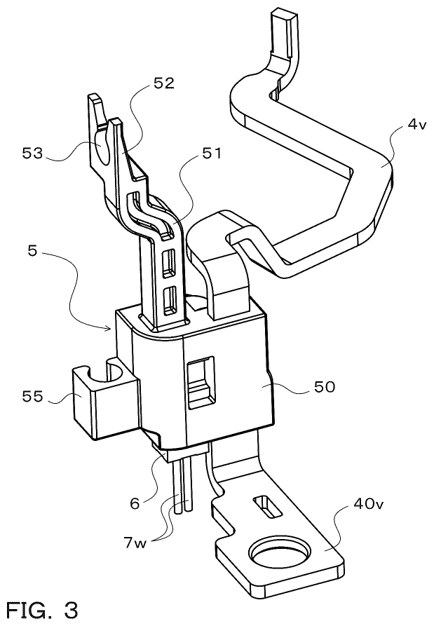

The sensor holding member 5 includes a main body 50, a connector support portion 51 extending from the main body 50, and a cable support portion 55 integrally formed with the main body 50, as shown in FIGS. 2 and 3. In this embodiment, the sensor holding member 5 is integrally formed with the power lines 4v or 4w and the temperature sensor 6 by injecting resin into a mold in which the power lines 4v or 4w and the temperature sensor 6 are inserted. The main body 50 holds the temperature sensor 6 such that the two wires 7w connected to a sensor element are exposed on the side of the tip 40v or 40w (lower side in the figure) of the power line 4v or 4w. In addition, the tube 7t of the cable 7 covers the two wires 7w such that the two wires 7w are slightly exposed in the vicinity of the temperature sensor 6 (main body 50) and the vicinity of the connector 8.

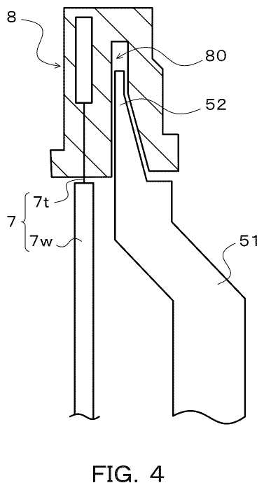

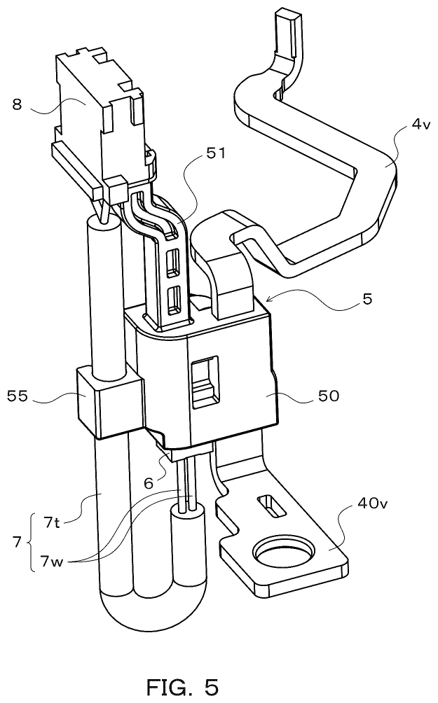

The connector support portion 51 of the sensor holding member 5 extends from the main body 50 to the opposite side (upper side in the figure) of the tip 40v or 40w, and a tip 52 of the connector support portion 51 is formed to be insertable into a recess 80 formed in the connector 8, as shown in FIGS. 4 and 5. In addition, a notch 53 is formed in the tip 52 of the connector support portion 51, which is capable of holding (grasping) the tube 7t of the cable 7. The cable support portion 55 extends outward from a side of the main body 50, and is formed to slidably support the tube 7t of the cable 7 in an extending direction (up and down direction in the figure) of the connector support portion 51, as shown in FIG. 5.

When the power lines 4v and 4w, which are integrated with the sensor holding member 5, are connected to the stator coils 3v and 3w, and when the stator 1 is completed with the attachment of other parts and the like, the stator 1 is assembled to the case 10 in a state where the connector 8 is supported by the tip 52 of the connector support portion 51 and the tube 7t of the cable 7 is slidably supported by the cable support portion 55 (see FIG. 5). Thus, by supporting the connector 8 of the temperature sensor 6 on the connector support portion 51 of the sensor holding member 5 when assembling the stator 1 in the case 10, the movement of the connector 8 is restricted, and the movement range of the connector 8 and cable 7 is narrowed. As a result, the need to secure a large movement range for the connector 8 and the like, and to suppress interference between the moving connector 8, etc., and the case 10, etc., is reduced, thereby making it possible to suppress the enlargement of assembly equipment for the stator 1 and the case 10. Furthermore, in the stator 1, the connector 8, which is detachably supported by the connector support portion 51, can be grasped by a robot not shown in the figure and coupled to the corresponding receptacle 12 of the case 10. As a result, there is no need to manually couple the connector 8 to the receptacle 12, thereby improving the ease of assembly of the stator 1 to the case 10.

In the stator 1, the connector 8 of the temperature sensor 6 is coupled to the receptacle 12 mounted on the case 10, and the connector support portion 51 of the sensor holding member 5 includes a notch 53 capable of holding the tube 7t of the cable 7 that extends between the temperature sensor 6 and the connector 8 coupled to the receptacle 12. That is, in the stator 1, as shown in FIG. 2, the notch 53 (tip 52) of the connector support portion 51 of the sensor holding member 5, which is integrated with the V-phase power line 4v, holds the tube 7t of the cable 7 that extends between the temperature sensor 6 held by the sensor holding member 5, which is integrated with the W-phase power line 4w, and the connector 8 coupled to the receptacle 12. This makes it possible to arrange the cable 7 inside the case 10 without interfering with other parts and the like, while suppressing the increase in the number of parts.

The cable 7 (tube 7t) held by the notch 53 of the connector support portion 51 is not limited to the one connected to the temperature sensor 6 held by the sensor holding member 5 other than the sensor holding member 5 including said connector support portion 51. In other words, the cable 7 held by the notch 53 of the connector support portion 51 may be connected to the temperature sensor 6 held by the sensor holding member 5 including said connector support portion 51. For example, in FIG. 2, the notch 53 (tip 52) of the connector support portion 51 of the sensor holding member 5, which is integrated with the power line 4w of the W phase, may hold the cable 7 that extends between the temperature sensor 6 held by the sensor holding member 5, which is integrated with the power line 4w of the W phase, and the connector 8 coupled to the corresponding receptacle 12.

Further, the sensor holding member 5 includes a cable support portion 55 that slidably supports the cable 7 (tube 7t) connected to the temperature sensor 6 and the connector 8. This allows the length of the cable 7 pulled out from the side of the stator 1 (sensor holding member 5) to be adjusted, thereby enabling the cable 7 to be properly routed within the case 10.

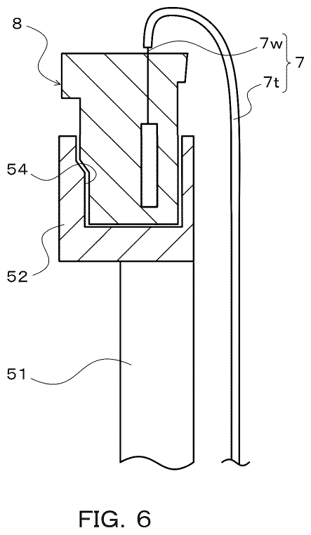

Furthermore, the connector support portion 51 of the sensor holding member 5 includes the tip 52 as an insertion portion that is inserted into the recess 80 formed in the connector 8. This allows the connector support portion 51, which detachably supports the connector 8, to be formed in the sensor holding member 5 without complicating the structure of the sensor holding member 5. The connector support portion 51 does not necessarily have to include the insertion portion that is inserted into the connector 8. That is, as shown in FIG. 6, the tip 52 of the connector support portion 51 may have a fitting portion (a recess) 54 in which the connector 8 is detachably fitted. This also allows the connector support portion 51, which supports the connector 8 detachably, to be formed in the sensor holding member 5 without complicating the structure of the sensor holding member 5. In addition, the tip 52 of the connector support portion 51 shown in FIG. 6 may also be formed to be able to hold the tube 7t of the cable 7.

Furthermore, the conductor to which the sensor holding member 5 is integrated is not limited to the power lines 4v, 4w connected to the stator coils 3v, 3w, but may be at least one of the neutral lines 4n connected to the stator coils 3u, 3v, 3w. The conductor to which the sensor holding member 5 is integrated may also be at least one of the segment coils 30, 31 that form the stator coils 3u, 3v, 3w.

As has been described above, As explained above, the stator 1 of the present disclosure is disposed in the case 10 and includes the stator core 2, the stator coils 3u, 3v, and 3w wound on the stator core 2, the sensor holding member 5, and the connector support portion 51. The sensor holding member 5 is integrated with the power lines 4v, 4w or neutral line 4n as conductors included in the stator coils 3v, 3w, and also holds the temperature sensor 6. The connector support portion 51 is formed in the sensor holding member 5 to detachably support the connector 8 connected to the temperature sensor 6 via the cable 7. This makes it possible to suppress the enlargement of the assembly equipment for the stator 1 and the case 10, and also to improve the ease of assembly of the stator 1 to the case 10.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the manufacturing industry of the stator and the rotating electric machine.

1. A stator disposed in a case, the stator comprising:
a stator core;
a stator coil wound around the stator core;
a sensor holding member that is integrated with a conductor included in the stator coil and that holds a temperature sensor; and
a connector support portion that is formed in the sensor holding member to detachably support a connector connected to the temperature sensor via a cable.

2. The stator according to claim 1, wherein:
the connector is coupled to a receptacle disposed in the case; and
the connector support portion is formed to hold the cable that extends between the temperature sensor and the connector coupled to the receptacle.

3. The stator according to claim 1, wherein:
the sensor holding member includes a cable support portion that slidably supports the cable connected to the temperature sensor and the connector.

4. The stator according to claim 1, wherein:
the connector support portion includes an insertion portion that is detachably inserted into a recess formed in the connector, or a fitting portion into which the connector is detachably fitted.

5. The stator according to claim 1, wherein:
the conductor is a power line or a neutral line connected to the stator coil.
